(19) United States
(12) Patent Application Publication
(10) Pub. No.: US 2026/0005935 A1
(43) Pub. Date: Jan. 1, 2026

(54) KNOWN DATA INDICATOR FOR TIME DOMAIN COUPLED CONTROL INFORMATION TRANSMISSIONS

(71) Applicant: QUALCOMM Incorporated, San Diego, CA (US)

(72) Inventors: Shravan Kumar Reddy GARLAPATI, San Diego, CA (US); Wei YANG, San Diego, CA (US); Afshin HAFTBARADARAN, San Diego, CA (US); Alessandro RISSO, San Diego, CA (US); Li ZHANG, San Diego, CA (US); Jing JIANG, San Diego, CA (US)

(21) Appl. No.: 18/759,653

(22) Filed: Jun. 28, 2024

(51) Int. Cl. H04L 41/5009; H04L 1/00; H04W 72/0446; H04W 72/231

(52) U.S. Cl. CPC H04L 41/5009; H04L 1/0038; H04W 72/0446; H04W 72/231

(57) ABSTRACT

Various aspects of the present disclosure generally relate to wireless communication. In some aspects, a receiver may receive a known data indicator (KDI) indicating whether a next control information transmission comprises one or more fields associated with values that are unchanged with respect to a preceding control information transmission. The receiver may receive the next control information transmission. The receiver may decode the next control information transmission in accordance with the KDI. Numerous other aspects are described.

### FIELD OF THE DISCLOSURE

Aspects of the present disclosure generally relate to wireless communication and specifically relate to techniques, apparatuses, and methods associated with a known data indicator for time domain coupled control information transmissions.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication at a receiver. The apparatus may include one or more memories and one or more processors coupled to the one or more memories. The one or more processors may be configured to receive a known data indicator (KDI) indicating whether a next control information transmission comprises one or more fields associated with values that are unchanged with respect to a preceding control information transmission. The one or more processors may be configured to receive the next control information transmission. The one or more processors may be configured to decode the next control information transmission in accordance with the KDI.

Some aspects described herein relate to an apparatus for wireless communication at a transmitter. The apparatus may include one or more memories and one or more processors coupled to the one or more memories. The one or more processors may be configured to transmit, to a receiver, a KDI indicating whether a next control information transmission comprises one or more fields associated with values that are unchanged with respect to a preceding control information transmission. The one or more processors may be configured to transmit, to the receiver, the next control information transmission, wherein the receiver is configured to decode the next control information transmission in accordance with the KDI.

Some aspects described herein relate to a method of wireless communication performed by a receiver. The method may include receiving, by the receiver, a KDI indicating whether a next control information transmission comprises one or more fields associated with values that are unchanged with respect to a preceding control information transmission. The method may include receiving, by the receiver, the next control information transmission. The method may include decoding, by the receiver, the next control information transmission in accordance with the KDI.

Some aspects described herein relate to a method of wireless communication performed by a transmitter. The method may include transmitting, by the transmitter to a receiver, a KDI indicating whether a next control information transmission comprises one or more fields associated with values that are unchanged with respect to a preceding control information transmission. The method may include transmitting, by the transmitter to the receiver, the next control information transmission, wherein the receiver is configured to decode the next control information transmission in accordance with the KDI.

Some aspects described herein relate to a non-transitory computer-readable medium that stores a set of instructions for wireless communication by a receiver. The set of instructions, when executed by one or more processors of the receiver, may cause the receiver to receive a KDI indicating whether a next control information transmission comprises one or more fields associated with values that are unchanged with respect to a preceding control information transmission. The set of instructions, when executed by one or more processors of the receiver, may cause the receiver to receive the next control information transmission. The set of instructions, when executed by one or more processors of the receiver, may cause the receiver to decode the next control information transmission in accordance with the KDI.

Some aspects described herein relate to a non-transitory computer-readable medium that stores a set of instructions for wireless communication by a transmitter. The set of instructions, when executed by one or more processors of the transmitter, may cause the transmitter to transmit, to a receiver, a KDI indicating whether a next control information transmission comprises one or more fields associated with values that are unchanged with respect to a preceding control information transmission. The set of instructions, when executed by one or more processors of the transmitter, may cause the transmitter to transmit, to the receiver, the next control information transmission, wherein the receiver is configured to decode the next control information transmission in accordance with the KDI.

Some aspects described herein relate to an apparatus for wireless communication. The apparatus may include means for receiving a KDI indicating whether a next control information transmission comprises one or more fields associated with values that are unchanged with respect to a preceding control information transmission. The apparatus may include means for receiving the next control information transmission. The apparatus may include means for decoding the next control information transmission in accordance with the KDI.

Some aspects described herein relate to an apparatus for wireless communication. The apparatus may include means for transmitting, to a receiver, a KDI indicating whether a next control information transmission comprises one or more fields associated with values that are unchanged with respect to a preceding control information transmission. The apparatus may include means for transmitting, to the receiver, the next control information transmission, wherein the receiver is configured to decode the next control information transmission in accordance with the KDI.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of mappings for ordering control information fields, in accordance with the present disclosure.

FIG. 5 is a diagram illustrating an example associated with time domain coupling control information transmissions, in accordance with the present disclosure.

FIGS. 6A-6C are diagrams illustrating examples associated with signaling time domain coupled control information transmissions, in accordance with the present disclosure.

FIG. 7 is a diagram illustrating examples associated with encoding control information transmissions, in accordance with the present disclosure.

FIGS. 8A-8B are diagrams illustrating examples associated with decoding control information transmissions, in accordance with the present disclosure.

FIG. 9 is a diagram illustrating an example associated with a known data indicator (KDI) for time domain coupled control information transmissions, in accordance with the present disclosure.

FIG. 10 is a diagram illustrating examples associated with an aggregation level for time domain coupled control information transmissions, in accordance with the present disclosure.

FIG. 11 is a diagram illustrating examples associated with encoding time domain coupled control information transmissions in accordance with a KDI, in accordance with the present disclosure.

FIG. 12 is a flowchart illustrating an example process performed, for example, by a UE in accordance with the present disclosure.

FIG. 13 is a flowchart illustrating an example process performed, for example, by a network node in accordance with the present disclosure.

FIG. 14-15 are diagrams of example apparatuses for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, polar codes are often used to encode control information, such as downlink control information (DCI) on downlink channels, uplink control information (UCI) on uplink channels, and/or sidelink control information (SCI) on sidelink channels. As described herein, the encoded control information may generally include various fields to manage wireless communication. For example, a network node may transmit DCI to a user equipment (UE) on a physical downlink control channel (PDCCH) to indicate various parameters associated with downlink communication, such as a time domain resource allocation (TDRA), a frequency domain resource allocation (FDRA), a modulation and coding scheme (MCS), and/or a hybrid automatic repeat request (HARQ) process number or HARQ feedback timing, among other examples. In addition, a UE may transmit UCI to a network node on a physical uplink control channel (PUCCH) to indicate parameters associated with uplink communication, such as HARQ feedback to acknowledge or indicate errors in received downlink transmissions, channel state information (CSI) to report parameters related to channel quality, and/or provide a scheduling request (SR) to request uplink resources, and a UE may receive SCI (e.g., from a network node or another UE) that indicates parameters associated with sidelink communication, such as resource scheduling, synchronization information, and/or power control information, among other examples.

In some cases, control information may have one or more fields with values (e.g., one or more bits) that are unchanged over multiple consecutive control information transmissions. In a given DCI, UCI, or SCI transmission, some fields may include one or more bits with values that are unchanged with respect to a previous control information transmission (e.g., “known bits”), and some fields may carry one or more bits with values that are different from the previous control information transmission (e.g., “unknown bits”). For example, in one scenario, a network node may have a full downlink data buffer that corresponds to a UE when the UE is streaming a movie, television program, sporting event, or the like. In this example, the network node may be aware, in advance, that enough content is stored in the data buffer to transmit to the UE over the next several hundred or several thousand slots. Furthermore, one or more DCI fields may have a correlation in time over multiple consecutive DCI transmissions (e.g., many slots may have multiple DCI transmission bursts, with each DCI transmission burst potentially having one or more DCI fields with values that are unchanged or otherwise correlated in time).

Accordingly, when one or more control information fields have the same value over multiple consecutive control information transmissions, a receiver can theoretically exploit the unchanged value(s) to improve decoding performance. For example, because values (or known bits) associated with the unchanged fields are available from a previously decoded control information transmission, the receiver can avoid decoding the known bits in a subsequent control information transmission. However, the receiver may be unable to exploit the fact that one or more control information fields have unchanged values because the receiver may be unaware when a certain field in a control information payload has changed with respect to a previous control information transmission prior to decoding, and/or may not know how long a value associated with a given field remains constant over multiple consecutive transmissions. As a result, the receiver may consume processing resources and/or power resources decoding the field(s) with the unchanged value(s), latency may be increased because the receiver needs to spend time decoding the field(s) with the unchanged value(s), decoding performance may be degraded because errors may occur when the receiver attempts to decode the field(s) with the unchanged value(s), and/or network resources may be consumed because the transmitter has to utilize more resource blocks (RBs) for each control information transmission to achieve a targeted block error rate (BLER).

Various aspects described herein relate generally to coupling control information transmissions in a time domain, and to a known data indicator (KDI) for time domain coupled control information transmissions. For example, in some aspects, a transmitter may indicate, to a receiver, one or more fields in a control information transmission that have values that will remain unchanged over multiple consecutive transmissions and/or how long a value associated with a field will remain constant or unchanged (e.g., a number of consecutive control information transmissions). For example, in some aspects, the transmitter may provide, to the receiver, a KDI that indicates whether a next control information transmission does or does not include one or more fields with values that are unchanged with respect to a preceding control information transmission (e.g., a control information transmission immediately preceding the next control information transmission).

In this way, the receiver may exploit the knowledge that one or more fields in a control information transmission have values that are unchanged with respect to a previous control information transmission, and may avoid decoding the known bits to conserve processing resources and/or power resources when decoding the control information transmission with the known bits. In addition, because the receiver already decoded the known bits in a preceding control information transmission, decoding performance may be improved for the control information transmission with the known bits. For example, the receiver may reliably decode the control information transmission with the known bits at a lower signal-to-noise ratio (SNR). Furthermore, when the KDI indicates that the next control information transmission includes known bits, the transmitter may use a lower aggregation level for the next control information transmission, which allows the transmitter to use fewer RBs for the next control information transmission (e.g., conserving network resources and transmission resources at the transmitter) while achieving the same targeted BLER and using the same control information format as the preceding control information transmission.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

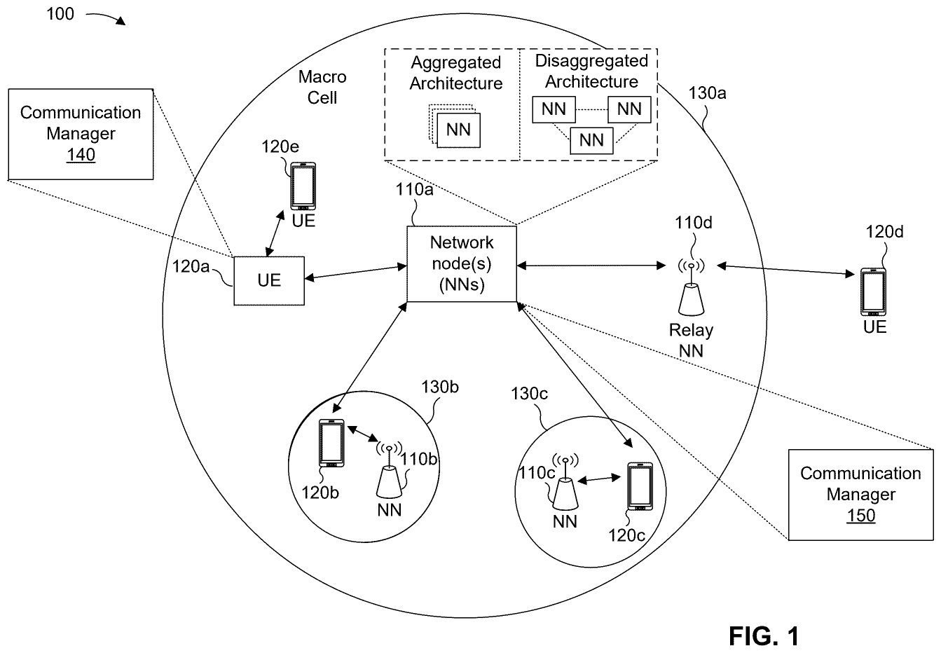

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHZ). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more PDCCHs, and downlink data channels may include one or more physical downlink shared channels (PDSCHs). Uplink channels may similarly include one or more control channels and one or more data channels. An uplink control channel may be used to transmit UCI (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a KDI indicating whether a next control information transmission comprises one or more fields associated with values that are unchanged with respect to a preceding control information transmission; receive the next control information transmission; and decode the next control information transmission in accordance with the KDI. Additionally, or alternatively, the communication manager 140 may transmit, to a receiver, a KDI indicating whether a next control information transmission comprises one or more fields associated with values that are unchanged with respect to a preceding control information transmission; and transmit, to the receiver, the next control information transmission, wherein the receiver is configured to decode the next control information transmission in accordance with the KDI. Additionally, or alternatively, the communication manager 140 may perform one or more other operations described herein.

In some aspects, the network node 110 may include a communication manager 150. As described in more detail elsewhere herein, the communication manager 150 may receive a KDI indicating whether a next control information transmission comprises one or more fields associated with values that are unchanged with respect to a preceding control information transmission; receive the next control information transmission; and decode the next control information transmission in accordance with the KDI. Additionally, or alternatively, the communication manager 150 may transmit, to a receiver, a KDI indicating whether a next control information transmission comprises one or more fields associated with values that are unchanged with respect to a preceding control information transmission; and transmit, to the receiver, the next control information transmission, wherein the receiver is configured to decode the next control information transmission in accordance with the KDI. Additionally, or alternatively, the communication manager 150 may perform one or more other operations described herein.

As indicated above, FIG. 1 is provided as an example. Other examples may differ from what is described with regard to FIG. 1.

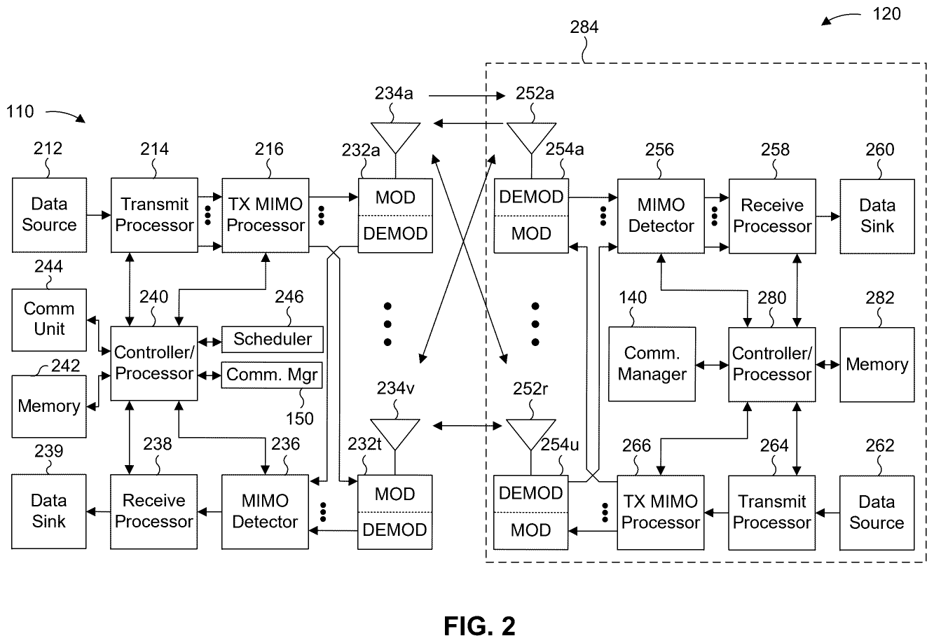

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

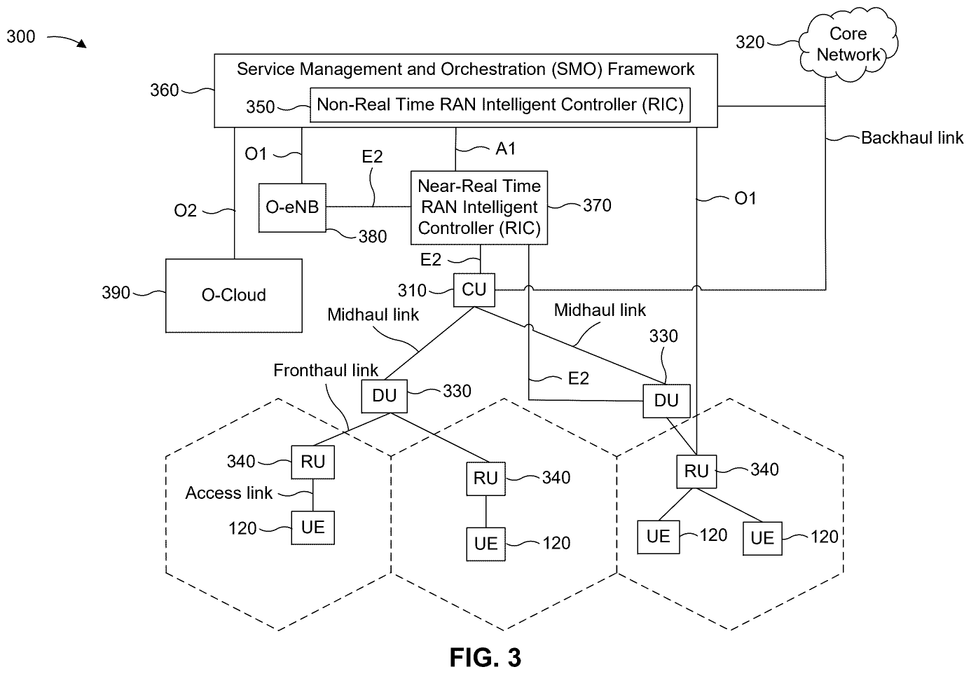

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

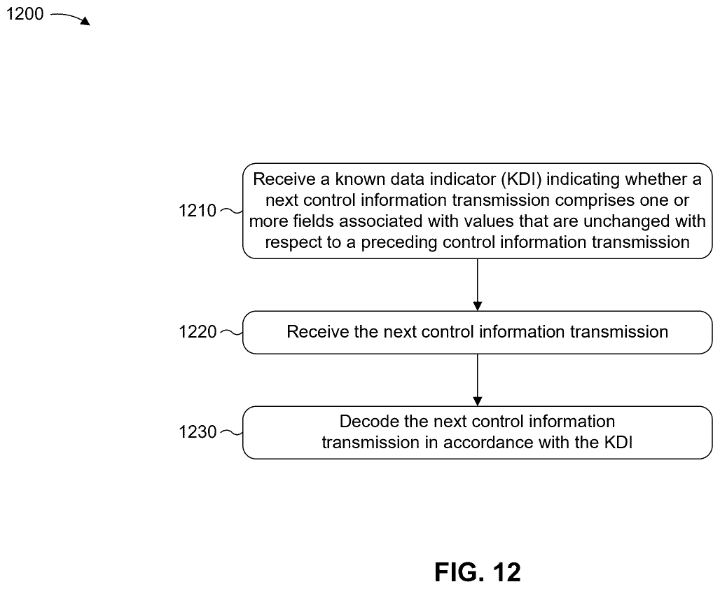

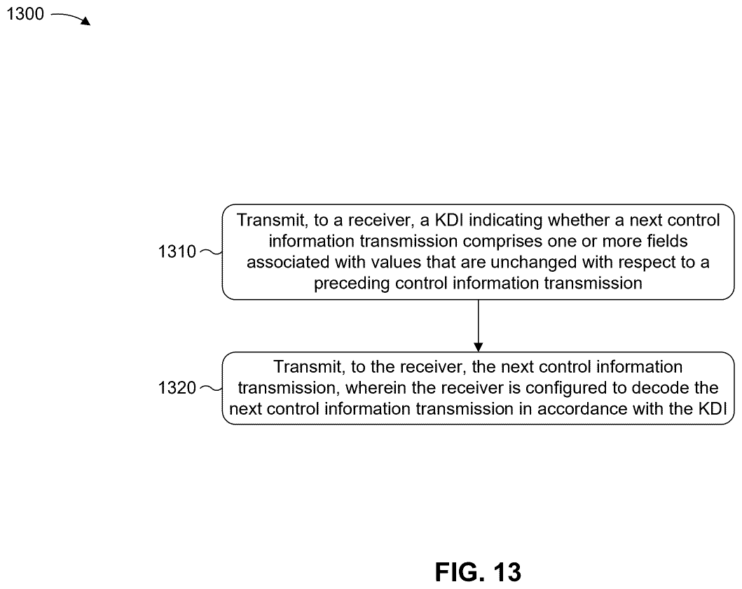

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a KDI for time domain coupled control information transmissions, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1200 of FIG. 12, process 1300 of FIG. 13, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1200 of FIG. 12, process 1300 of FIG. 13, or other processes as described herein. In some examples, executing instructions may include running the instructions, converting the instructions, compiling the instructions, and/or interpreting the instructions, among other examples.

In some aspects, the UE 120 includes means for receiving a KDI indicating whether a next control information transmission comprises one or more fields associated with values that are unchanged with respect to a preceding control information transmission; means for receiving the next control information transmission; and/or means for decoding the next control information transmission in accordance with the KDI. Additionally, or alternatively, the UE 120 includes means for transmitting, to a receiver, a KDI indicating whether a next control information transmission comprises one or more fields associated with values that are unchanged with respect to a preceding control information transmission; and/or means for transmitting, to the receiver, the next control information transmission, wherein the receiver is configured to decode the next control information transmission in accordance with the KDI. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving a KDI indicating whether a next control information transmission comprises one or more fields associated with values that are unchanged with respect to a preceding control information transmission; means for receiving the next control information transmission; and/or means for decoding the next control information transmission in accordance with the KDI. Additionally, or alternatively, the network node 110 includes means for transmitting, to a receiver, a KDI indicating whether a next control information transmission comprises one or more fields associated with values that are unchanged with respect to a preceding control information transmission; and/or means for transmitting, to the receiver, the next control information transmission, wherein the receiver is configured to decode the next control information transmission in accordance with the KDI. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

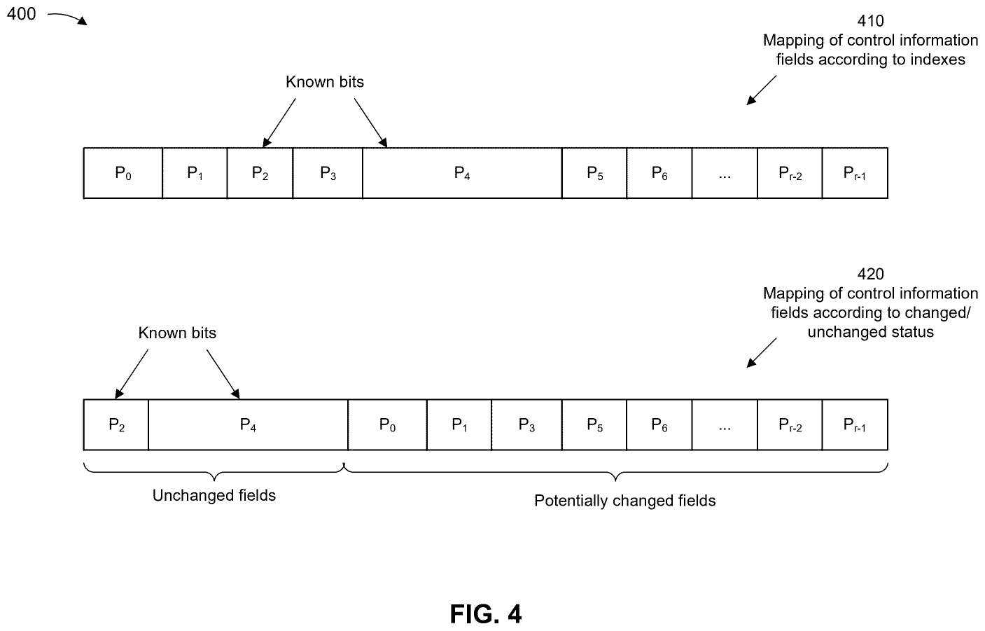

FIG. 4 is a diagram illustrating examples 400 of mappings for ordering control information fields, in accordance with the present disclosure.

In a wireless network, polar codes are often used to encode control information, such as DCI on uplink channels, uplink control information (UCI) on uplink channels, and/or sidelink control information (SCI) on sidelink channels. As described herein, the encoded control information may generally include various fields to manage wireless communication. For example, a network node may transmit DCI to a UE on a PDCCH to indicate various parameters associated with downlink communication, such as a TDRA, an FDRA, an MCS, and/or a HARQ process number or HARQ feedback timing, among other examples. In addition, a UE may transmit UCI to a network node on a PUCCH to indicate parameters associated with uplink communication, such as HARQ feedback to acknowledge or indicate errors in received downlink transmissions, CSI to report parameters related to channel quality, and/or provide an SR to request uplink resources, and a UE may receive SCI (e.g., from a network node or another UE) that indicates parameters associated with sidelink communication, such as resource scheduling, synchronization information, and/or power control information, among other examples.

In some cases, control information may have one or more fields with values (e.g., one or more bits) that are unchanged over multiple consecutive control information transmissions. In a given DCI, UCI, or SCI transmission, some fields may include one or more bits with values that are unchanged with respect to a previous control information transmission (e.g., “known bits”), and some fields may carry one or more bits with values that are different from the previous control information transmission (e.g., “unknown bits”). For example, in one scenario, a network node may have a full downlink data buffer that corresponds to a UE when the UE is streaming a movie, television program, sporting event, or the like. In this example, the network node may be aware, in advance, that enough content is stored in the data buffer to transmit to the UE over the next several hundred or several thousand slots. Furthermore, one or more DCI fields may have a correlation in time over multiple consecutive DCI transmissions (e.g., many slots may have multiple DCI transmission bursts, with each DCI transmission burst potentially having one or more DCI fields with values that are unchanged or otherwise correlated in time). For example, in DCI, fields that can have a strong correlation in time include a DCI format indicator, a DMRS ports field, an MCS field, a TDRA field, an FDRA field, a transmit power control (TPC) field, a DMRS pattern field, a HARQ feedback timing field, a PUCCH resource indicator, and/or an SRS request field, among other examples. In addition, DCI fields such as a HARQ process number, a new data indicator (NDI), a redundancy version (RV), and/or a downlink assignment index (DAI) can have non-uniform probability distributions over all possible values. Furthermore, certain UCI and/or SCI fields may be correlated in time and/or have non-uniform probability distributions.

As described herein, a wireless network may generally support multiple formats for control information transmissions. For example, a wireless network may support multiple DCI formats (e.g., DCI format 0_0 or 0_1 for uplink scheduling, DCI format 1_0 or 1_1 for downlink scheduling, DCI format 2_0 for indicating a slot format, and/or DCI format 3_0 for sidelink scheduling, among other examples). In general, each DCI format (DCIF) may be associated with a set of fields, denoted P₀ to Pᵣ₋₁. As shown by reference number 410 in FIG. 4, the fields associated with a given DCIF are typically mapped in an increasing order of respective indexes (e.g., P₀ is mapped to a first field, and Pᵣ₋₁ is mapped to a final field). As further shown in FIG. 4, one or more fields (e.g., fields P₂ and P₄) include “known bits” in the sense that one or more bits associated with the fields have values that remain unchanged over multiple consecutive DCI transmissions. However, when using the mapping shown by reference number 410, where the various fields are mapped in an increasing order of respective indexes, the fact that the values of fields P₂ and P₄ are unchanged over multiple consecutive DCI transmissions is not indicated in the DCI, whereby a polar decoder at a UE without advanced capabilities assumes that every DCI field changes in each DCI transmission. Furthermore, although a UE with more advanced capabilities may perform additional processing to find the locations of unknown bits, the UE may be unable to find the locations of unknown bits with certainty. In addition, for a given number of known bits, a UE with capabilities to find the locations of unknown bits may observe a lower improvement in performance gain for the mapping shown by reference number 410 compared to the mapping shown by reference number 420 (where control information fields are mapped according to their changed/unchanged status). Furthermore, similar issues may apply to UCI fields, where the receiver is a network node and the transmitter is a UE, and to SCI fields, where the receiver is a UE and the transmitter is a network node or a UE (e.g., depending on the sidelink scheduling mode).

As described herein, in cases where one or more fields in a control information transmission remain unchanged over multiple consecutive control information transmissions and the receiver knows which fields are unchanged, the receiver can use this knowledge to increase decoding performance starting from a second control information transmission in a given time correlation window length of multiple consecutive control information transmissions. For example, if the receiver was able to successfully decode the first control information transmission, the receiver does not have to decode the unchanged fields when attempting to decode the second control information transmission. Instead, the receiver may obtain the values for the unchanged fields from a decoding result associated with the first control information transmission.

As described herein, a wireless network may employ polar codes for DCI and UCI transmissions, and a polar encoder-decoder pair at a transmitter and a receiver can exploit the “known bits” or unchanged fields to significantly enhance decoding performance (e.g., transmission and decoding reliability). For example, at the transmitter, a polar transform during encoding polarizes one or more synthetic channels to very good channels and very poor channels. Good channels generally have a higher transmission reliability, and poor channels generally have a lower transmission reliability (e.g., where channel indexes are in an increasing order of reliability). During encoding, the transmitter may select K=A+CRC (e.g., where A is a payload size and CRC is a number of bits for a cyclic redundancy code (CRC), such as 24 bits) channel indexes that are the most reliable out of N available channel indexes, and map K information bits to K channel indexes of an N bit vector in an increasing order of respective indexes, and the remaining N−K indexes in the N-bit vector are set to zero. This may be referred to as a K-to-N mapping. However, in cases where “known bits” or unchanged fields are distinguished from “unknown bits” or fields that may or may not have changed, before polar encoding, the transmitter may place the “known bits” in the least reliable locations and the “unknown bits” in the most reliable locations. Depending on the percentage of “known bits” from the previous transmission, significant improvement in decoding performance may be achieved for the subsequent control information transmissions. For example, as shown by reference number 420 in FIG. 4, a control information mapping may be defined where the “known bits” or unchanged fields (e.g., fields P₂ and P₄) are mapped to the least reliable locations and the “unknown bits” or potentially changed fields (e.g., fields P₀, P₁, P₃, P₅, . . . . Pᵣ₋₁) are mapped to the most reliable locations.

Accordingly, as described herein, when there is a coupling between control information fields over multiple consecutive control information transmissions, where one or more fields have “known bits” or values that are unchanged over multiple consecutive control information transmissions, the multiple consecutive control information transmissions may be associated with a time domain coupling (e.g., where control information fields, such as DCI fields, UCI fields, or SCI fields, associated with a given control information format are mapped in according to a changed/unchanged or known/unknown status, as shown by reference number 420 in FIG. 4).

As indicated above, FIG. 4 is provided as an example. Other examples may differ from what is described with regard to FIG. 4.

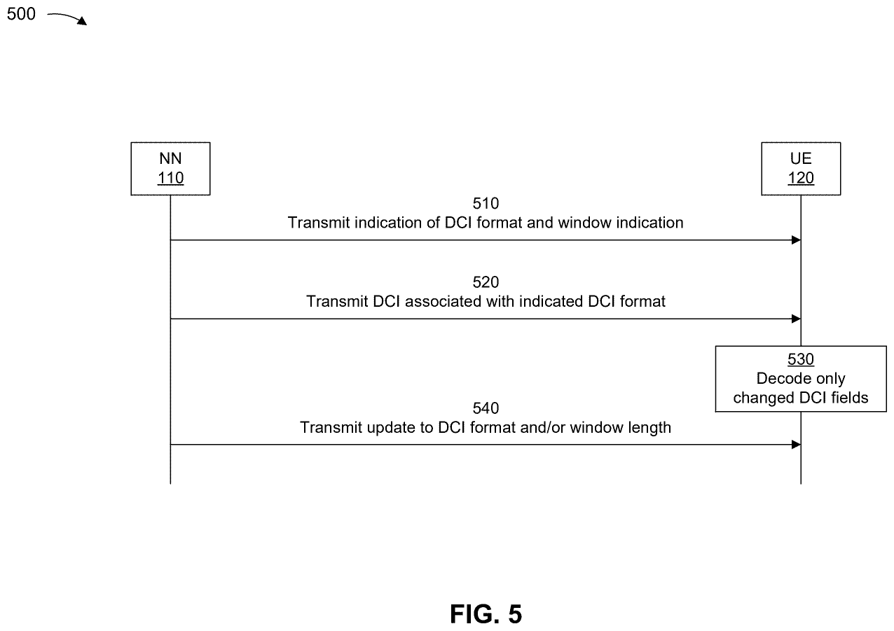

FIG. 5 is a diagram illustrating an example 500 associated with time domain coupling control information transmissions, in accordance with the present disclosure. As shown in FIG. 5, example 500 includes communication between a network node 110 and a UE 120 via a wireless network (e.g., wireless communication network 100). Although example 500 is described in a context related to time domain coupling for DCI transmissions, the same or similar techniques may be applied for time domain coupling UCI and/or SCI transmissions.

In some aspects, the network node 110 may indicate a time-domain coupling of DCIs over multiple consecutive transmissions to the UE 120 via a window length and by rearranging DCI fields (e.g., as described above with respect to FIG. 4, where known bits corresponding to unchanged fields are placed in the least reliable locations and unknown bits corresponding to potentially changed fields are placed in the most reliable locations). This indication aids the K-to-N mapping to map the unchanged fields (known bits) to the least reliable indexes and potentially changed fields (unknown bits) to the most reliable indexes.

As shown by reference number 510, the network node 110 may transmit an indication of a DCI format with changed fields (one or more fields with changed values since the previous DCI transmission) that follow unchanged fields (one or more fields with unchanged values since the previous DCI transmission). The network node 110 may also transmit a window length indication that indicates a window length for how long (e.g., how many slots or monitoring occasions) the unchanged fields are to remain unchanged. The UE 120 may receive the indication and the window indication. As shown by reference number 520, the network node 110 may transmit a DCI transmission having the DCI format. The UE 120 may receive the DCI.

As shown by reference number 530, the UE 120 may decode the unchanged fields of the DCI and may refrain from decoding the unchanged fields. In some aspects, the unchanged fields may be consecutive fields at the beginning of the DCI transmission, and the changed fields may be consecutive fields of the DCI transmission that start after a last unchanged field. In some aspects, the UE 120 may start decoding at a first field of the changed fields.

In some aspects, the changed fields and the unchanged fields (e.g., the order of the fields) may be permutated (e.g., rearranged) with respect to a reference DCI format, to obtain the new DCI format. For example, DCI formats 0_0, 1_1, 1_0, and 0_1, among others, may be defined in a wireless communication standard. With a change in channel characteristics, a number of fields that the network node 110 selects to remain the same in a given window can change. This may involve a permutation of DCI fields to keep all unchanged fields at the beginning of the DCI transmission and changed fields at the end of the DCI transmission. The permutation of DCI fields results in a new DCI format that is derived from a reference DCI format given in a wireless communication standard. One or more changed fields may be mapped to higher reliability bit indexes of a polar encoder input than the one or more unchanged fields.

As described herein, a DCIF may be referred to as a base DCIF (BDCIF), where BDCIFs may be DCIFs that are defined in a wireless communication standard. As described herein, a BDCIF may be defined in a wireless communication standard as BDCIF_X, where X indicates a different DCI format (e.g., 0_0, 1_0, 1_1, or 0_1, among other examples). For example, referring to FIG. 4, the DCI field mapping shown by reference number 420 may be a permuted version of the DCI field mapping shown by reference number 410, and may be a permuted DCIF (PDCIF) that is a permuted version of BDCIF. As there can be many permutations of a given BDCIF_X, the permutations may be indexed as PDCIF_X_Y, where Y indicates an index corresponding to a possible permutation of BDCIF_X. BDCIF_X may also be indexed as PDCIF_X_0 and any other permutations may be indexed as PDCIF_X_1, PDCIF_X 2, . . . , PDCIF_X_Y. In each of these permuted versions, only the fields with values that are expected to remain unchanged over a given window length (w) of multiple consecutive transmissions are placed at the beginning of the DCI transmission, and the remaining fields are placed at the end of the DCI transmission (e.g., in an increasing order of respective indexes or another suitable order, which may be defined in a wireless communication standard, indicated via RRC signaling, or the like). Accordingly, each PDCIF_X_Y index may implicitly indicate how many fields at the beginning are to remain the same over w slots. Each valid PDCIF_X_Y may be defined in a wireless communication standard, or the network node 110 may indicate, to the UE 120 via RRC signaling, a MAC-CE, or other suitable signaling, the order of fields and the number of fields at the beginning of a DCI transmission that are to remain unchanged over the window length w. The network node 110 may also transmit the window indication via RRC signaling, a MAC-CE, or other suitable signaling. The window length w may be defined as the number of consecutive DCI slots or other transmission intervals. Even if there is no DCI transmission in some slots (empty slots), these slots are counted as a part of the window length w. With an empty slot, the network node 110 may indicate to the UE 120 that some fields that were expected to remain unchanged in a window may start to change in the middle of a window starting from the next DCI transmission after the empty slot. In the case of TDD systems, w may be defined as a number of consecutive slots or other transmission intervals, some of which may include uplink slots or uplink intervals. Whether uplink intervals are included in or excluded from the window length, and/or how many uplink intervals are included in the window length, may be defined in a wireless communication standard and/or indicated to the UE 120 via appropriate signaling.

In some aspects, as shown by reference number 540, the network node 110 may transmit an update of the DCI format and/or an update of the window length.

As indicated above, FIG. 5 is provided as an example. Other examples may differ from what is described with regard to FIG. 5.

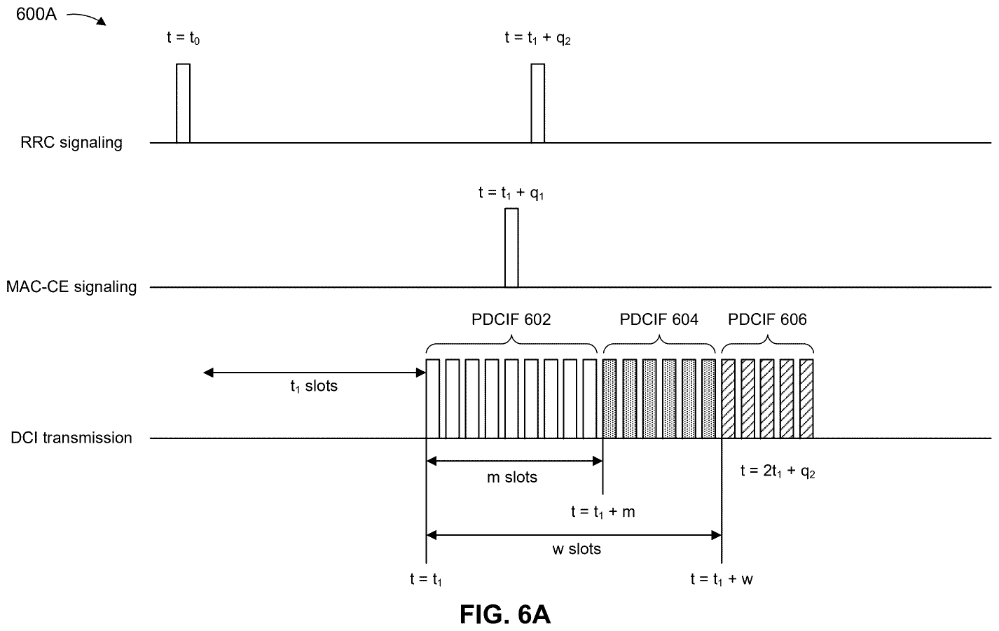

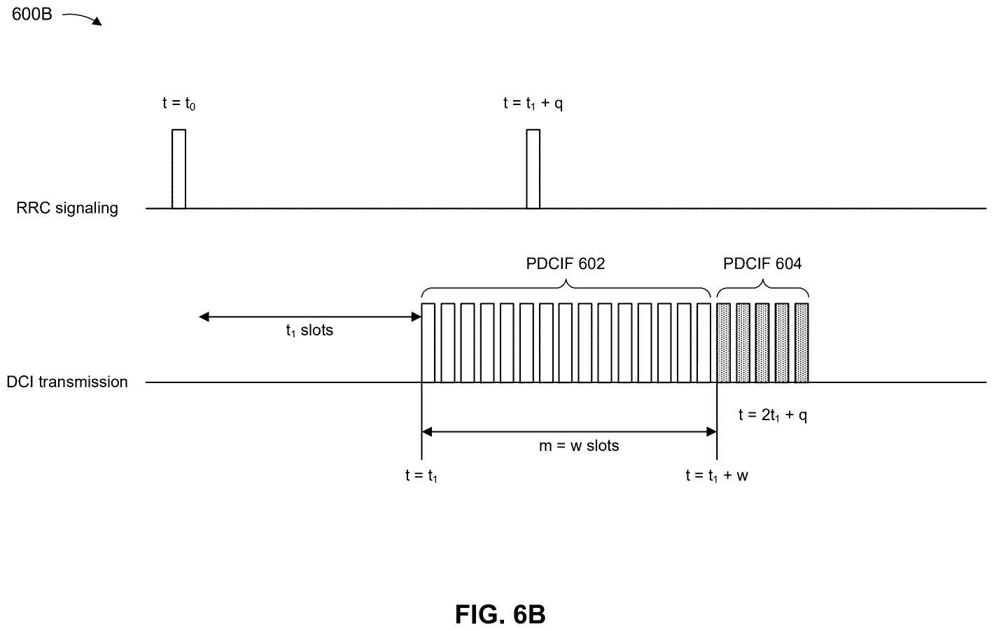

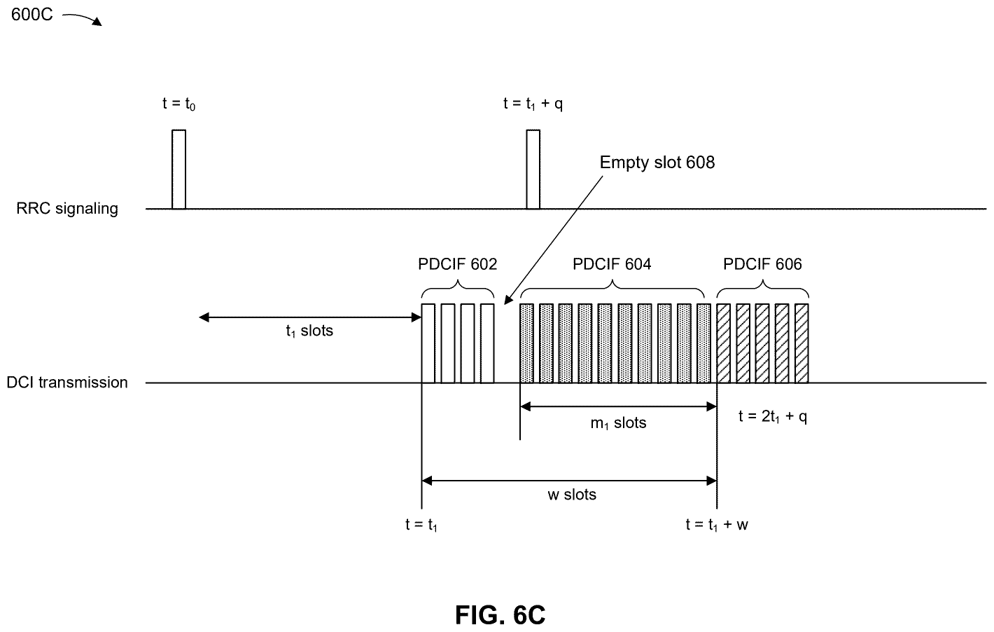

FIGS. 6A-6C are diagrams illustrating examples 600A, 600B, 600C associated with signaling time domain coupled control information transmissions, in accordance with the present disclosure. Although examples 600A, 600B, 600C are described in a context related to time domain coupling for DCI transmissions, the same or similar techniques may be applied for time domain coupling UCI and/or SCI transmissions.

Example 600A shows a timing diagram and a representation of a message exchange between a network node 110 and a UE 120. At a first time (e.g., at time instance t=t₀), the network node 110 may transmit an indication of a DCI format (e.g., an index associated with a first PDCIF 602) via an RRC message. After an RRC setup or reconfiguration delay at t=t₁, the network node 110 may start to transmit DCI using the first PDCIF 602. The window length w may include slots for which the fields of PDCIF 602 remain unchanged. In example 600A, the window length w may generally exceed an RRC setup or RRC reconfiguration delay. Within the window w, at t=t₁+m, if the value of one or more known bits is expected to change, the network node 110 may indicate this information to the UE 120. In some cases, an RRC setup or RRC reconfiguration delay may be high. If the network node 110 were to wait the length of the RRC setup or RRC reconfiguration delay (e.g., 10 milliseconds (ms)) to indicate a DCIF change to the UE 120, there may be a delay in the communication. To avoid the delay, the network node 110 may transmit a MAC-CE to the UE 120 for faster (e.g., dynamic) signaling of special control information. For example, MAC-CE action timing may be less than the RRC delay (e.g., around 3 ms).

If w is large enough and if the known bits are expected to be changed within w slots (e.g., at t=t₁+m), at t=t₁+q₁, the network node 110 may transmit a MAC-CE to the UE 120 to indicate a new PDCIF 604 for DCI transmissions starting at t=t₁+m. At the end of w slots (t=t₁+w), if the network node 110 is expected to change the DCIF to PDCIF 606 at t=t₁+q₂, the network node 110 may indicate to the UE 120 via RRC signaling that the network node 110 will use PDCIF 606 for DCI transmissions starting at t=t₁+w. At t=t₁+w, the network node 110 may start using PDCIF 606 for DCI transmissions.

In example 600A, detailed RRC and MAC-CE signaling between the network node 110 and the UE 120 is to be expected as specified in wireless communication standards. The parameters t₁, q₁, q₂, m, and w may be variable. In example 600A, m is expected to exceed MAC-CE action timing, and w is expected to exceed RRC setup or RRC reconfiguration delays. However, for other scenarios, the values of m and w may be different. The smallest possible window length where control information transmissions can be coupled in a time domain may be w=2 slots (e.g., where only two consecutive slots have one or more fields with unchanged values). In such an example, known bit values may change in every even slot, and known bit values may remain the same as a preceding DCI transmission in every odd slot. As the value of w increases, the UE 120 may experience larger reductions in resource consumption. For example, FIG. 6A illustrates one MAC-CE signal between two RRC signals to update the DCI format, but there may be multiple MAC-CE exchanges between any two RRC exchanges related to a DCI format update for a larger window length w.

In some aspects, as shown by example 600B in FIG. 6B, a number of slots over which the first PDCIF 602 includes fields associated with unchanged values may equal the window length (e.g., m=w). In such cases, the DCI format remains unchanged during the window w, and thus there is no MAC-CE signaling, in contrast with the MAC-CE signaling shown in example 600A. As shown by example 600B, the communication related to a DCI format change occurs via RRC signaling.

Additionally, or alternatively, in some aspects, the network node 110 may initially expect a larger window length w, but may change known bits within the window m due to a change in channel characteristics (e.g., as shown in example 600A). However, in cases where the network node 110 does not have enough time to update the UE 120 about the DCIF change via MAC-CE signaling, the network node 110 may not change the payload of the known bits through consecutive slots. To change the known bits without any RRC or MAC-CE signaling, the network node 110 may wait for one slot. Hence, as shown in example 600C in FIG. 6C, there may be an empty slot 608 where the network node 110 does not transmit any DCI to the UE 120 in one slot. In such cases, starting from the subsequent slot in that window w (e.g., following the empty slot 608), the network node 110 may not change the DCI format (e.g., because the network node 110 cannot communicate the DCI format change to the UE 120), but may change the value of one or more known bits. Accordingly, as shown in example 600C, the DCI transmissions in a window of m₁ slots after the empty slot 608 may have new values for one or more known bits relative to the DCI transmissions prior to the empty slot 608, and the new values for the one or more known bits may remain unchanged over the window of m₁ slots. If the network node 110 were to change the value of one or more known bits again during the window of m₁ slots, there would be another empty slot. If w is large (e.g., equals or exceeds a threshold), the percentage of empty slots may be negligible. If w is set to be small (e.g., equal to or below a threshold), there may not be a need for empty slots. In example 600C, if m₁ satisfies (e.g., equals or exceeds) a threshold, the network node 110 may use MAC-CE signaling to update the UE 120 about the DCI format change and may use a different DCI format for DCI transmissions in the middle of the window of m₁ slots.

In example 600C, the time domain coupling is interrupted in the middle of the window, but the network node 110 does not explicitly communicate the interruption to the UE 120. The empty slot 608 aids the UE 120 in recognizing the interruption in the time domain coupling, and thus the UE 120 may decode the subsequent DCIs, considering all of the fields/bits as unknown. Without the empty slot 608, the UE 120 may decode DCI transmissions within the window w assuming that the known bits are unchanged, even though the bits may have actually changed. Accordingly, the empty slot 608 may avoid a CRC failure for the DCI transmissions where the values of one or more known bits may have changed.

As indicated above, FIGS. 6A-6C are provided as examples. Other examples may differ from what is described with regard to FIGS. 6A-6C.

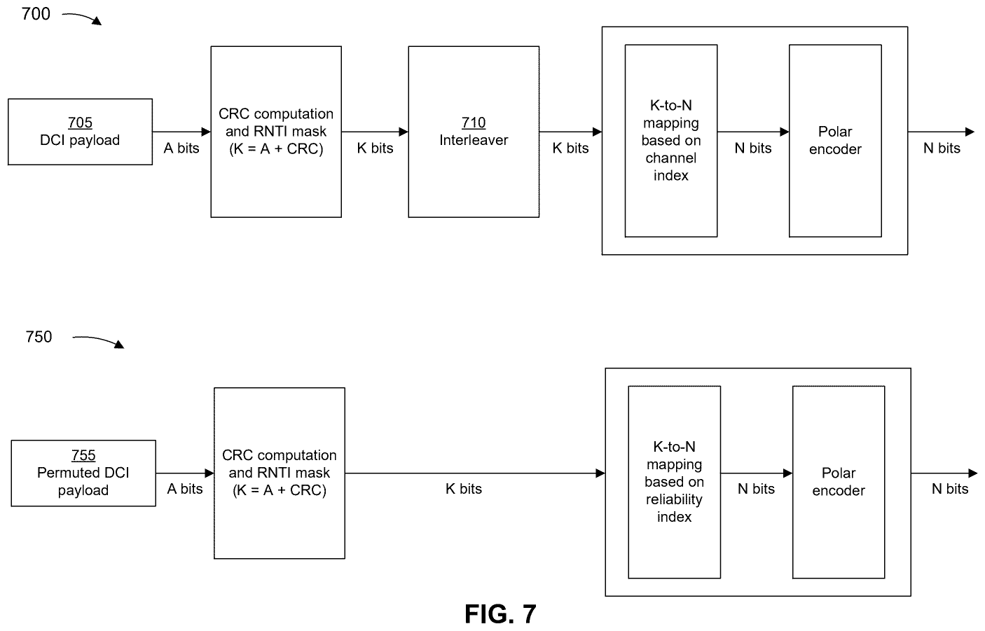

FIG. 7 is a diagram illustrating examples 700 and 750 associated with encoding control information transmissions, in accordance with the present disclosure. In particular, examples 700 and 750 relate to encoding DCI transmissions, although the same or similar techniques may be applied for UCI and/or SCI transmissions.

As described herein, example 700 shows a DCI encoding chain in a network node 110, starting with a DCI payload 705. A radio temporary network identifier (RNTI) mask may be used for the CRC of the DCI payload 705 before an interleaver 710 interleaves DCI fields for mapping to a polar encoder. Example 750 shows the changes in the DCI encoding associated with the time domain coupling for DCI transmissions described herein. In some aspects, a difference between example 700 and example 750 is that, in example 700, K bits (e.g., a DCI payload 705 and a CRC) are interleaved before performing a K-to-N mapping function that is based on a channel index. In example 750, K bits are not interleaved so as to allow for a permuted DCI payload 755, where the DCI fields associated with a DCI format are rearranged according to a mapping that relates to whether the DCI fields have values that remain unchanged over multiple consecutive DCI transmissions (e.g., where known bits are packed in the beginning of the permuted DCI payload 755 and unknown bits are packed after the known bits). For example, there is no interleaving for the permuted DCI payload 755 because interleaving may shift one or more known bits to more reliable locations and/or may shift one or more unknown bits to less reliable locations.

As indicated above, FIG. 7 is provided as an example. Other examples may differ from what is described with regard to FIG. 7.

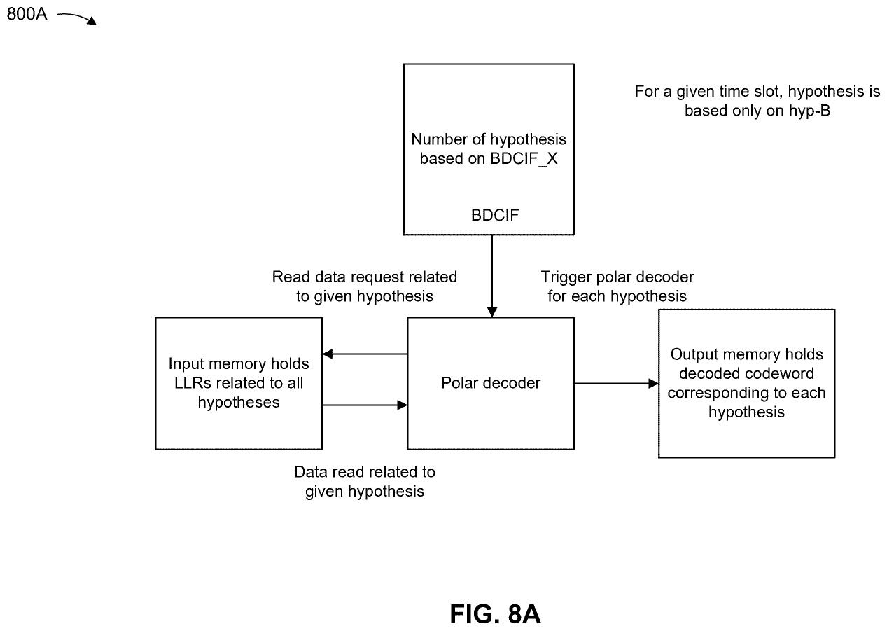

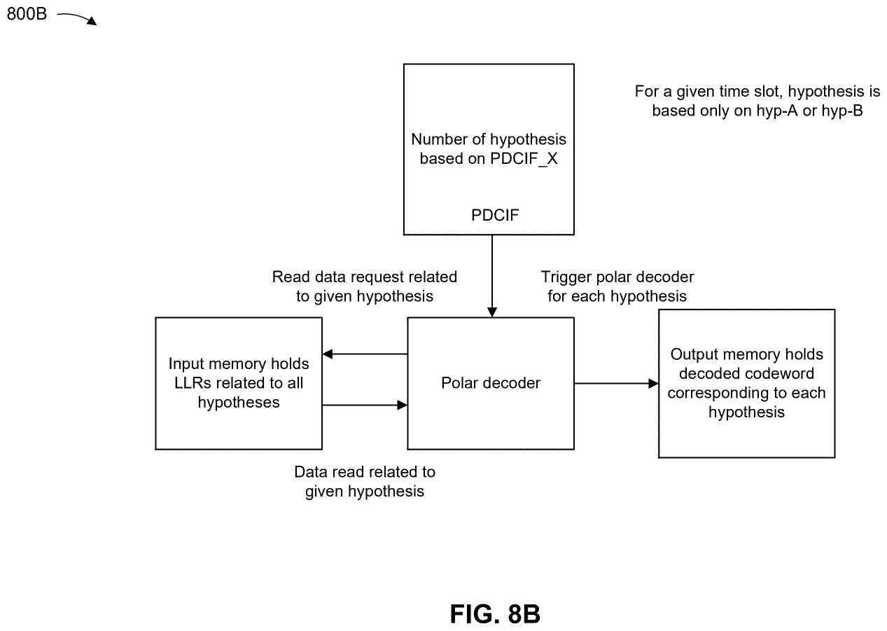

FIGS. 8A-8B are diagrams illustrating examples 800A and 800B associated with decoding control information transmissions, in accordance with the present disclosure. In particular, examples 800A and 800B relate to decoding DCI transmissions, although the same or similar techniques may be applied for UCI and/or SCI transmissions.

Referring to FIG. 8A, example 800A shows a decoding technique generally used at a UE 120 to decode a DCI transmission. The UE 120 may perform blind bit/field decoding to decode the DCI transmission. In general, one or more wireless communication standards specify DCI formats such as DCI format 0_0, 0_1, 1_0, 1_1, or the like. In example 800A, BDCIF_X may be one of these DCI formats. The hypothesis hyp-A may correspond to a hypothesis where a certain j number of fields at the beginning of the DCI payload (depending on a BDCIF) are the same over multiple consecutive transmissions. The hypothesis hyp-B may correspond to a hypothesis where all of the fields are unknown. In existing wireless communication standards, decoding the hypothesis is based on an expectation that all fields in a DCI payload are unknown.

Alternatively, example 800B in FIG. 8B shows a decoding methodology that can leverage time domain coupling for control information transmissions to improve decoding performance. As described herein, a given PDCIF may be transmitted over a window of m slots. Hence, within the window of m slots, after the first detected DCI transmission, the UE 120 may expect all known DCI fields to remain constant across the remainder of the window. Therefore, at the UE 120, in the first time slot among the m time slots, if there is a passing hypothesis (hyp), bits corresponding to j fields are known for the remaining (m−1) slots. While the UE 120 is decoding the hypothesis in the subsequent (m−1) slots, bits of j fields are treated as known bits. This aids the UE 120 in significantly improving the decoding performance in the next (m−1) slots. Also, the UE 120 may decode the DCI in subsequent (m−1) slots at a lower SNR. In the first time slot, hyp-B may be decoded and in the remaining time slots, hyp-A is decoded.

In some aspects, during a given timing window m or w, the network node 110 may communicate, to the UE 120, that the PCDIF has j fields that remain constant. If hyp-A does not pass in any slot (i^{th} slot), starting from an (i+1)th slot to an m^{th} or w^{th} slot, the UE 120 may decode hyp-B (all the bits are assumed to be unknown). In some cases, the i^{th} slot could be an empty slot and hence there is no passing hypothesis. With the time domain coupling of DCI transmissions, the general decoding methodology is that, even though the window length w is greater than 2, the UE 120 may expect that the time correlation only applies to consecutive DCI transmissions. If there is no correlation between consecutive DCI transmissions, the UE 120 may automatically fall back to hyp-B decoding. In this approach, the number of hypotheses remains the same as in existing wireless communication standards, but the benefits of the time domain coupling are manifest in i−1 slots, but not in the remaining m₁ slots. Therefore, to take advantage of time domain coupling for DCI transmissions in the remaining m₁ slots, if hyp-B passes in the (i+1)th slot, the UE 120 may attempt hyp-A again starting from the (i+2)th slot and repeat this process based on CRC pass/fail. Hence, as shown in example 800B, the decoding hypothesis may switch between hyp-A and hyp-B.

As indicated above, FIGS. 8A-8B are provided as examples. Other examples may differ from what is described with regard to FIGS. 8A-8B.

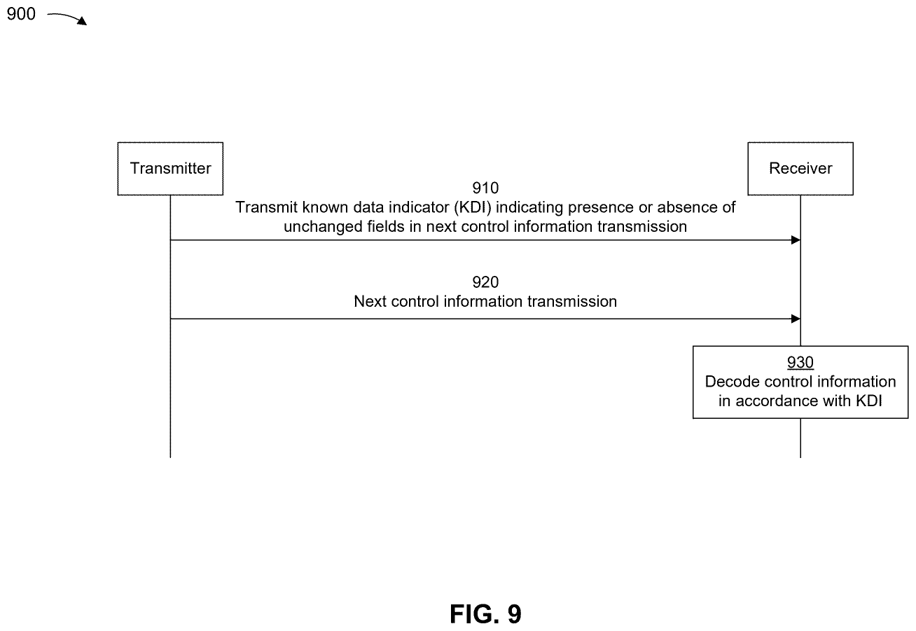

FIG. 9 is a diagram illustrating an example 900 associated with a KDI for time domain coupled control information transmissions, in accordance with the present disclosure. As shown in FIG. 9, example 900 includes communication between a transmitter and a receiver via a wireless network (e.g., wireless communication network 100). For example, in some aspects, the transmitter may be a network node 110 and the receiver may be a UE 120 for time domain coupling DCI transmissions, the transmitter may be a UE 120 and the receiver may be a network node 110 for time domain coupling UCI transmissions, and/or the transmitter may be a network node 110 or a UE 120 and the receiver may be a UE 120 for time domain coupling SCI transmissions.

As shown in FIG. 9, and by reference number 910, the transmitter may transmit, and the receiver may receive, a KDI that indicates the presence or absence of one or more unchanged fields in a next control information transmission. For example, as described herein, control information transmissions (e.g., DCI, UCI, or SCI) may have one or more fields with values that are unchanged over multiple consecutive transmissions, where such fields are generally considered “known bits” when control information transmissions are coupled in a time domain. For example, as described herein, the term “known bits” may generally refer to a set of j control information fields that have the same value or an unchanged value over multiple consecutive transmissions for a given permuted control information format (e.g., PDCIF_X_Y for a permuted DCI format) associated with a given base control information format (e.g., BDCIF_X for a base DCI format). Accordingly, the KDI provided to the receiver may generally indicate whether “known bits” or fields with unchanged values exist in a next control information transmission, which may allow the receiver to avoid decoding the fields with unchanged values. For example, in some aspects, the receiver may obtain the values associated with the unchanged fields from a successful decoding result associated with the control information transmission preceding the control information transmission that includes the known bits, which may conserve processing resources at the receiver, reduce latency, and/or improve decoding performance (e.g., enabling the control information to be decoded at a lower SNR). In addition, in cases where the transmitter uses an aggregation level for transmitting the control information and the number of known bits satisfies (e.g., equals or exceeds) a threshold, the transmitter may use a lower aggregation level for a next DCI transmission for the same targeted BLER. For example, as described herein, an aggregation level generally defines a number of control channel elements (CCEs) that are used for a control channel transmission, where an aggregation level may be 1, 2, 4, or 8 for DCI transmissions. In this way, when the transmitter is able to lower an aggregation level for DCI transmissions with a large number of known bits or unchanged fields (e.g., reducing the number of CCEs from 16 to 8), the number of RBs that are needed to transmit the control information is reduced without increasing the BLER and without any change to the control information format.

In some aspects, as described herein, the KDI may generally include one or more bits that the transmitter communicates to the receiver to indicate whether known bits exist in a next control information transmission (e.g., following the KDI). For example, in some aspects, the KDI may be a one-bit indicator, which may have a first value (e.g., KDI=1) to indicate that known bits exist in the next control information transmission, or a second value (e.g., KDI=0) to indicate that known bits do not exist in the next control information transmission. Accordingly, in cases where the KDI indicates that known bits exist in the next control information transmission, the receiver may exploit the known bits to improve decoding performance for the next control information transmission (e.g., by decoding only the unknown bits and obtaining the values for the known bits from the previous control information transmission). Furthermore, in cases where the transmitter uses an aggregation level for control information transmissions, the transmitter may autonomously change (e.g., reduce) the aggregation level for the next control information transmission (e.g., reducing the aggregation level from 16 to 8) and maintain the same control information format. In such cases, the receiver may be unaware of the change to the aggregation level, and can still decode the appropriate hypothesis because the receiver performs blind decoding across each candidate aggregation level. For example, in some aspects, the transmitter may transmit, and the receiver may receive, information indicating the candidate aggregation levels for control information transmission via RRC signaling or other appropriate signaling. In this way, the number of RBs used to transmit the control information may be reduced, which may conserve resources at the transmitter and/or conserve network resources. Furthermore, because the receiver knows the values of the known bits from previous control information transmissions, the receiver can decode a current control information transmission with a lower aggregation level, assuming the same target BLER for both the control information transmissions.

Alternatively, in some aspects, the KDI may include multiple bits, where a least significant bit of the KDI indicates whether a next control information transmission includes one or more fields with values that are unchanged with respect to a preceding control information transmission (e.g., KDI[0]=1 indicates that known bits exist in the next control information transmission, and KDI[0]=0 indicates that known bits do not exist in the next control information transmission). Furthermore, one or more most significant bits of the KDI may indicate a set of candidate aggregation levels associated with the next control information transmission. For example, in some aspects, the transmitter may indicate, to the receiver (e.g., via RRC signaling), a first set of one or more candidate aggregation levels (e.g., {AL8=864, AL16=1728}) and a second set of one or more candidate aggregation levels (e.g., {AL4=432}) that may be used for control information transmissions. In this case, the one or more most significant bits of the KDI may be used to indicate which set of candidate aggregation levels will be used for the next control information transmission. For example, when two sets of candidate aggregation levels are configured, the two sets of candidate aggregation levels can be indicated using one bit, where KDI[1]=0 indicates that the first set of candidate aggregation levels is used for the next control information transmission such that the receiver hypothesizes among the candidate aggregation levels in the first set of candidate aggregation levels when performing blind decoding for the next control information transmission. Similarly, KDI[1]=1 indicates that the second set of candidate aggregation levels is used for the next control information transmission such that the receiver hypothesizes among the candidate aggregation levels in the second set of candidate aggregation levels when performing blind decoding for the next control information transmission. For example, the following table indicates supported values when the KDI is a two-bit field, and additional sets of aggregation levels may be supported by increasing the bitwidth of the KDI (e.g., using two bits in the KDI to indicate a set of candidate aggregation levels may support up to four sets of candidate aggregation levels, and using three bits in the KDI to indicate a set of candidate aggregation levels may support up to eight sets of candidate aggregation levels).

| KDI | |
|---|---|
| value | KDI interpretation |
| 00 | “Known bits” do not exist in the next control information |
| | transmission, and the first set of candidate aggregation levels is |
| | used such that the receiver hypothesizes among the aggregation |
| | levels in the first set of candidate aggregation levels for blind |
| | decoding. |
| 01 | “Known bits” are present in the next control information |
| | transmission, and the first set of candidate aggregation levels is |
| | used such that the receiver hypothesizes among the aggregation |
| | levels in the first set of candidate aggregation levels for blind |
| | decoding. |
| 10 | “Known bits” are not present in the next control information |
| | transmission, and the second set of candidate aggregation levels is |
| | used such that the receiver hypothesizes among the aggregation |
| | levels in the second set of candidate aggregation levels for blind |
| | decoding. |
| 11 | “Known bits” are present in the next control information |
| | transmission, and the second set of candidate aggregation levels is |
| | used such that the receiver hypothesizes among the aggregation |
| | levels in the second set of candidate aggregation levels for blind |
| | decoding. |

In some aspects, the KDI may have a fixed bitwidth (e.g., one bit, two bits, or the like) that is specified in a wireless communication standard, or the bitwidth may be configured via appropriate signaling (e.g., RRC signaling). For example, in some aspects, the transmitter may transmit, and the receiver may receive, one or more messages indicating the bitwidth of the KDI, where the bitwidth may control whether the KDI only indicates the presence or absence of known bits in the next control information transmission or a set of candidate aggregation levels used for the next control information transmission in addition to the presence or absence of known bits.

In some aspects, the transmitter may transmit the KDI to the receiver via a control information transmission (e.g., via a DCI transmission when the receiver is a UE 120, a UCI transmission when the receiver is a network node 110, or an SCI transmission when the receiver is a UE 120 operating in a sidelink mode). Additionally, or alternatively, the KDI may be multiplexed with a data transmission, such as a PDSCH when the transmitter is a network node 110 and the receiver is a UE 120. For example, in some aspects, the KDI may be multiplexed with a data transmission, sometimes referred to as piggybacked onto a data transmission, by puncturing the data transmission (e.g., in a similar manner as UCI carrying HARQ feedback with one or two bits multiplexed by puncturing a PUSCH). In such cases, multiplexing the KDI with a data transmission may typically require less than one percent of the resources allocated to the data transmission, and therefore result in negligible performance loss for the data transmission. In some aspects, in cases where the KDI is multiplexed with a data transmission, the KDI may be carried in a last OFDM symbol (e.g., symbol 14) of a slot in which the data transmitted is transmitted/received, which may provide the transmitter more time to predict the KDI value for the next control information transmission. Alternatively, the KDI may be carried in an earliest OFDM symbol among a first OFDM symbol that is X OFDM symbols prior to a last OFDM symbol of the slot and a second OFDM symbol corresponding to a last OFDM symbol of the data transmission. For example, transmitting the KDI in the OFDM symbol that is X OFDM symbols prior to the last OFDM symbol of the slot may provide the receiver with more time to process the KDI in slot n and to use the information conveyed by the KDI to decode the next control information transmission in slot n+1. Alternatively, in cases where the data transmission is relatively small and lasts until OFDM symbol Y, which is earlier than the last OFDM symbol in the slot (e.g., Y=7, which is less than 14), the KDI may be transmitted/received in OFDM symbol Y instead of waiting for the last OFDM symbol in the slot.

As further shown in FIG. 9, and by reference number 920, the transmitter may transmit, and the receiver may receive, the next control information transmission associated with the KDI. Furthermore, as shown by reference number 930, the receiver may then decode the next control information transmission in accordance with the KDI. For example, in cases where the KDI indicates that the next control information transmission does not include any known bits, the receiver may decode each field of the control information transmission. Alternatively, in cases where the KDI indicates that the next control information transmission does include known bits, the receiver may decode only one or more fields of the control information transmission that potentially have changed values (e.g., packed in the most reliable locations), and may refrain from decoding one or more fields that have values that are unchanged with respect to a previous control information transmission (e.g., packed in the least reliable locations). In some aspects, as described herein, the receiver may perform blind decoding for the unknown fields of the control information transmission by hypothesizing among a set of candidate aggregation levels associated with the control information transmission. For example, when the control information transmission has a large number of unchanged fields, the transmitter may autonomously reduce the aggregation level for the control information transmission, and the receiver may perform blind decoding across all candidate aggregation levels. Additionally, or alternatively, the transmitter may configure multiple sets of candidate aggregation levels, and the KDI may include one or more bits to indicate the sets of candidate aggregation levels used for the control information transmission. In such cases, the receiver may determine the set of candidate aggregation levels for the control information transmission according to the KDI (e.g., the one or more most significant bits of the KDI), and then hypothesize among the candidate aggregation levels in the indicated set of candidate aggregation levels when performing blind decoding for the control information transmission.

As indicated above, FIG. 9 is provided as an example. Other examples may differ from what is described with regard to FIG. 9.

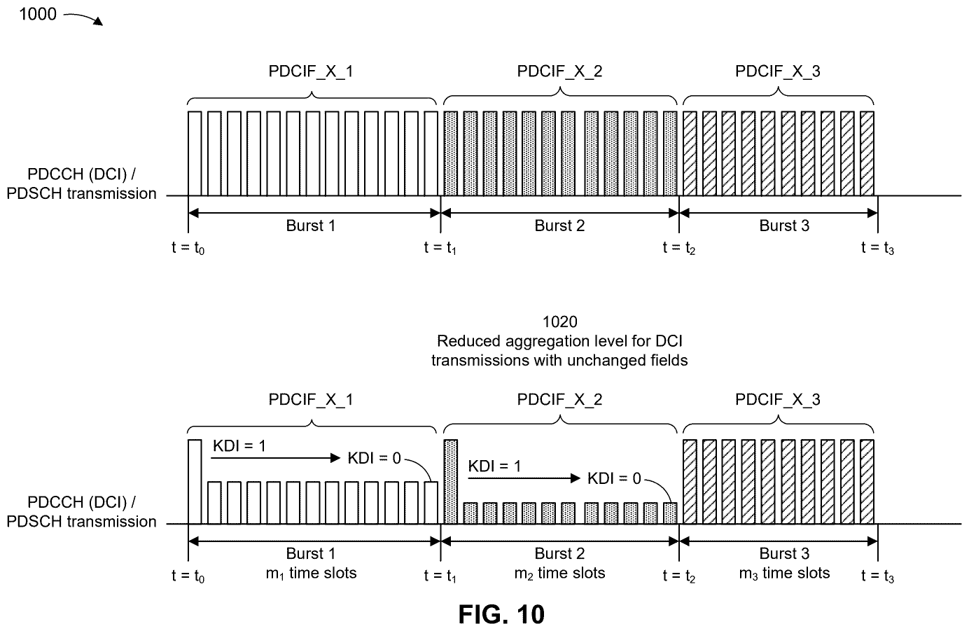

FIG. 10 is a diagram illustrating examples 1000 associated with an aggregation level for time domain coupled control information transmissions, in accordance with the present disclosure. Examples 1000 correspond to aggregation levels that may be used for DCI transmissions, although the same or similar techniques may be applied for UCI and/or SCI transmissions.

More particularly, reference number 1010 corresponds to PDCCH (DCI) and PDSCH transmissions in a scenario where the same aggregation level is used for all DCI transmissions across multiple bursts (e.g., where a network node 110 does not provide a UE 120 with a KDI to indicate whether a next DCI transmission includes known bits), and reference number 1020 corresponds to PDCCH (DCI) and PDSCH transmissions in a scenario where an aggregation level may be varied for DCI transmissions that have one or more unknown fields (e.g., where a network node 110 provides a UE 120 with a KDI to indicate whether a next DCI transmission includes known bits). In both examples, a downlink transmission includes both a DCI transmission and a PDSCH transmission on the respective allotted symbols. In both depicted scenarios, there are three bursts, which include a first burst from time t=0 to t=t₁ associated with a first permuted DCI format (PDCIF_X_1) for DCI transmissions, a second burst from time t=t₁ to t=t₂ associated with a second permuted DCI format (PDCIF_X_2) for DCI transmissions, and a third burst from time t=t₂ to t=t₃ associated with a third permuted DCI format (PDCIF_X_3) for DCI transmissions.

In the scenario shown by reference number 1010, there is no distinction between “known bits” and “unknown bits” in a DCI transmission, whereby the same aggregation level is used for all DCI transmissions across the various bursts (although the aggregation level of DCI transmissions can change from one burst to another). In the scenario shown by reference number 1020, however, a KDI is either included in a DCI transmission or multiplexed on a PDSCH transmission to indicate whether “known bits” exist in the next DCI transmission. Furthermore, in some cases, the KDI may also be used to indicate the set of candidate aggregation levels for blind decoding. As shown by reference number 1020, in the first burst, KDI=1 (indicating that known bits are present in the next DCI transmission) for all the m₁ DCI transmissions in the first burst except the last DCI transmissions. For the last DCI transmission in the first burst, KDI=0 to indicate that the “known bits” may change in the next DCI transmission. In the scenario corresponding to reference number 1020, the change to the known bits corresponds to the start of the first DCI transmission in the second burst.

As shown by reference number 1020, the network node can change an aggregation level for the last (m₁−1) DCI transmissions in the first burst compared to the first DCI transmission in the first burst (e.g., where the aggregation level corresponds to a height of each transmission in FIG. 10). In some aspects, the network node 110 may reduce the aggregation level to reduce the number of RBs used for the DCI transmissions with unchanged fields. For example, the network node 110 may autonomously reduce the aggregation level, or may use a multi-bit KDI to indicate the set of candidate aggregation levels for DCI transmissions. For example, when the KDI has two bits, the network node 110 can indicate the set of candidate aggregation levels used for DCI transmissions via the most significant bit of the KDI, denoted KDI[1]. If a first set of candidate aggregation levels is used, the network node 110 may provide a KDI with KDI[1]=0, or may provide a KDI with KDI[1]=1 if a first set of candidate aggregation levels is used. Additionally, or alternatively, as described herein, the value of the most significant bits of the KDI may remain unchanged and the network node 110 can autonomously select a lower aggregation level within the same set of candidate aggregation levels. For example, as shown by reference number 1020 in FIG. 10, the network node 110 may change an aggregation level among DCI transmissions in the first burst and the second burst. For the DCI transmissions with an aggregation level changed from 16 to 8 in the first burst, the reduction in aggregation level reduces the number of RBs by 50%. Similarly, in the second burst, the number of RBs saved for the last (m₂-1) DCI transmissions (where an aggregation level of 4 is used) is around 75% compared to the first DCI transmission (where an aggregation level of 16 is used). Furthermore, if the number of “known bits” is not high or keeps changing from one DCI transmission to another, the aggregation level may remain unchanged across all DCI transmissions, as shown in the third burst.

As indicated above, FIG. 10 is provided as an example. Other examples may differ from what is described with regard to FIG. 10.

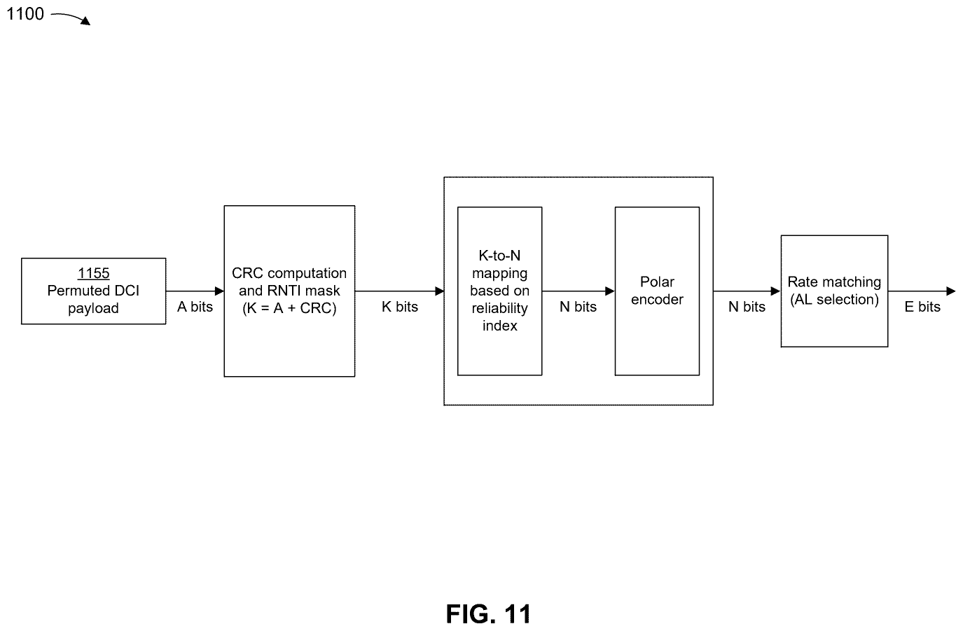

FIG. 11 is a diagram illustrating an example 1100 associated with encoding time domain coupled control information transmissions in accordance with a KDI, in accordance with the present disclosure. In particular, example 1100 relates to encoding time domain coupled DCI transmissions in accordance with a KDI, although the same or similar techniques may be applied for UCI and/or SCI transmissions.

In some aspects, as shown in FIG. 11, a permuted DCI payload 1155 may be input to the encoder, where the DCI payload includes known bits or fields associated with unchanged values that are packed at the beginning of the permuted DCI payload 1155, and unknown bits or fields associated with changed values that are packed after the known bits in the permuted DCI payload 1155. The permuted DCI payload 1155 may include A bits, and the encoder performs a CRC computation and RNTI masking function, and attaches the CRC bits to the A bits of the permuted DCI payload 1155. The encoder then passes K bits to a K-to-N mapping function, where K=A+CRC. The K bits are passed to the K-to-N mapping function without performing any interleaving (e.g., because interleaving may shift one or more known bits to more reliable locations and/or may shift one or more unknown bits to less reliable locations). The K-to-N mapping function may then determine a K-to-N mapping, mapping the K bits to N bits according to an increasing order of respective reliability indexes, and may pass the N bits to a polar encoder. The polar encoder may then generate a polar code that includes N bits, which may be passed to a rate matching function. For example, in some aspects, an aggregation level for DCI transmissions may vary (e.g., may be reduced within a burst) when one or more DCI transmissions include a relatively large number of unchanged fields. Accordingly, in some aspects, the rate matching function may perform aggregation level selection to select the aggregation level for a DCI transmission (e.g., according to a KDI value), and may output E bits associated with the selected aggregation level for transmission to a UE 120. For example, if there are relatively few (e.g., one or two) empty slots between DCI transmissions, the rate matching function may read the KDI value from a slot with a last (e.g., most recent) DCI transmission. Alternatively, if there are a relatively large number of empty slots between DCI transmissions, the network node 110 may reset the KDI to indicate that the next DCI transmission does not include known bits (e.g., may set KDI[0]=0), and the network node 110 may then start a new set of DCI transmissions.

As indicated above, FIG. 11 is provided as an example. Other examples may differ from what is described with regard to FIG. 11.

FIG. 12 is a diagram illustrating an example process 1200 performed, for example, at a receiver or an apparatus of a receiver, in accordance with the present disclosure. Example process 1200 is an example where the apparatus or the receiver (e.g., UE 120 or network node 110) performs operations associated with a KDI for time domain coupled control information transmissions.

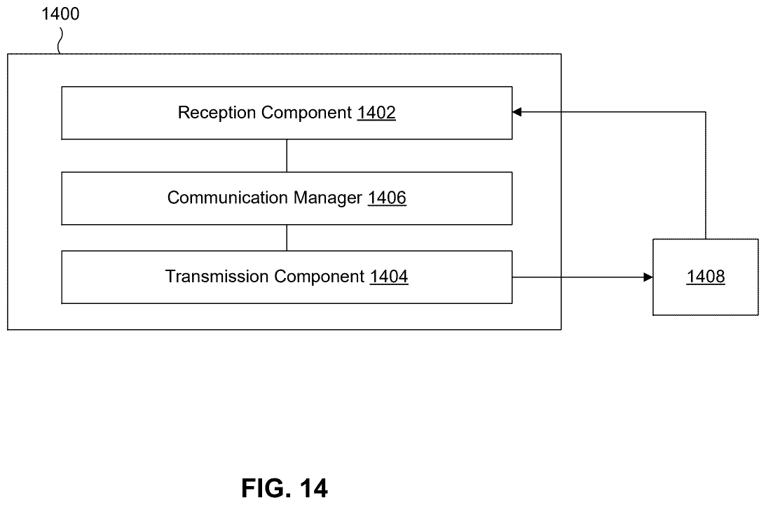

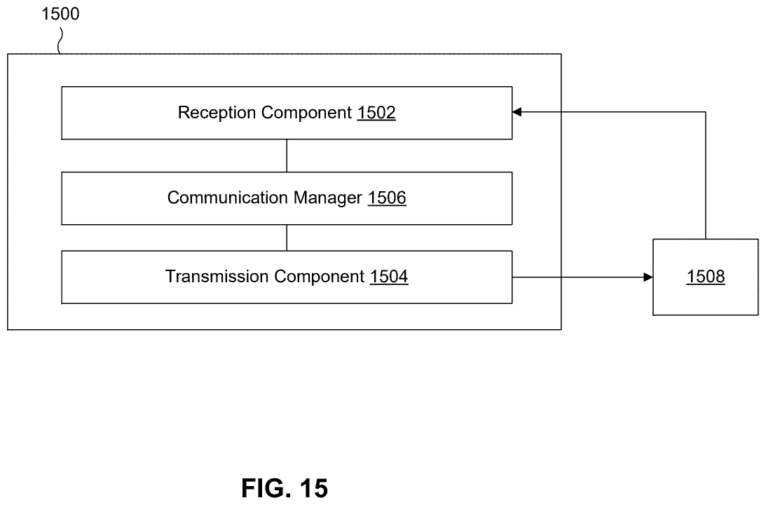

As shown in FIG. 12, in some aspects, process 1200 may include receiving a KDI indicating whether a next control information transmission comprises one or more fields associated with values that are unchanged with respect to a preceding control information transmission (block 1210). For example, the receiver (e.g., using reception component 1402 and/or communication manager 1406, depicted in FIG. 14, and/or using reception component 1502 and/or communication manager 1506, depicted in FIG. 15) may receive a KDI indicating whether a next control information transmission comprises one or more fields associated with values that are unchanged with respect to a preceding control information transmission, as described above.

As further shown in FIG. 12, in some aspects, process 1200 may include receiving the next control information transmission (block 1220). For example, the receiver (e.g., using reception component 1402 and/or communication manager 1406, depicted in FIG. 14, and/or using reception component 1502 and/or communication manager 1506, depicted in FIG. 15) may receive the next control information transmission, as described above.

As further shown in FIG. 12, in some aspects, process 1200 may include decoding the next control information transmission in accordance with the KDI (block 1230). For example, the receiver (e.g., using communication manager 1406, depicted in FIG. 14, and/or communication manager 1506, depicted in FIG. 15) may decode the next control information transmission in accordance with the KDI, as described above.

Process 1200 may include additional aspects, such as any single aspect or any combination of aspects described below and/or in connection with one or more other processes described elsewhere herein.

In a first aspect, decoding the next control information transmission comprises obtaining, from the preceding control information transmission, the unchanged values associated with the one or more fields in accordance with the KDI indicating that the next control information transmission comprises the one or more fields associated with the unchanged values.

In a second aspect, alone or in combination with the first aspect, decoding the next control information transmission comprises determining multiple candidate aggregation levels for the next control information transmission in accordance with the KDI indicating that the next control information transmission comprises the one or more fields associated with the unchanged values, and performing blind decoding for the next control information transmission across the multiple candidate aggregation levels for the next control information transmission.

In a third aspect, alone or in combination with one or more of the first and second aspects, process 1200 includes receiving, from a transmitter, signaling indicating the multiple candidate aggregation levels for the next control information transmission.

In a fourth aspect, alone or in combination with one or more of the first through third aspects, process 1200 includes receiving, from a transmitter, signaling indicating multiple sets of candidate aggregation levels, the KDI indicates a set of candidate aggregation levels, of the multiple sets of candidate aggregation levels, associated with the next control information transmission, and decoding the next control information transmission comprises performing blind decoding for the next control information transmission across one or more candidate aggregation levels associated with the set of candidate aggregation levels indicated in the KDI.

In a fifth aspect, alone or in combination with one or more of the first through fourth aspects, process 1200 includes receiving, from a transmitter, signaling indicating a bitwidth of the KDI.

In a sixth aspect, alone or in combination with one or more of the first through fifth aspects, the KDI has a fixed bitwidth.

In a seventh aspect, alone or in combination with one or more of the first through sixth aspects, the KDI is carried in the control information transmission preceding the next control information transmission.

In an eighth aspect, alone or in combination with one or more of the first through seventh aspects, the KDI is multiplexed with a data transmission preceding the next control information transmission.

In a ninth aspect, alone or in combination with one or more of the first through eighth aspects, the KDI is carried on a last symbol in a slot in which the data transmission is received.

In a tenth aspect, alone or in combination with one or more of the first through ninth aspects, the KDI is carried on an earliest symbol among a first symbol that is a configured number of symbols before a last symbol in a slot in which the data transmission is received or a second symbol corresponding to a last symbol of the data transmission.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a transmitter or an apparatus of a transmitter, in accordance with the present disclosure. Example process 1300 is an example where the apparatus or the transmitter (e.g., UE 120 or network node 110) performs operations associated with a KDI for time domain coupled control information transmissions.

As shown in FIG. 13, in some aspects, process 1300 may include transmitting a KDI indicating whether a next control information transmission comprises one or more fields associated with values that are unchanged with respect to a preceding control information transmission (block 1310). For example, the transmitter (e.g., using transmission component 1404 and/or communication manager 1406, depicted in FIG. 14, and/or using transmission component 1504 and/or communication manager 1506, depicted in FIG. 15) may transmit a KDI indicating whether a next control information transmission comprises one or more fields associated with values that are unchanged with respect to a preceding control information transmission, as described above.

As further shown in FIG. 13, in some aspects, process 1300 may include transmitting, to the receiver, the next control information transmission, wherein the receiver is configured to decode the next control information transmission in accordance with the KDI (block 1320). For example, the transmitter (e.g., using transmission component 1404 and/or communication manager 1406, depicted in FIG. 14, and/or using transmission component 1504 and/or communication manager 1506, depicted in FIG. 15) may transmit, to the receiver, the next control information transmission, wherein the receiver is configured to decode the next control information transmission in accordance with the KDI, as described above.

Process 1300 may include additional aspects, such as any single aspect or any combination of aspects described below and/or in connection with one or more other processes described elsewhere herein.

In a first aspect, process 1300 includes reducing an aggregation level for the next control information transmission, relative to the control information transmission preceding the next control information transmission, in accordance with the KDI indicating that the next control information transmission comprises the one or more fields associated with the unchanged values.

In a second aspect, alone or in combination with the first aspect, process 1300 includes transmitting, to the receiver, signaling indicating the multiple candidate aggregation levels for the next control information transmission.

In a third aspect, alone or in combination with one or more of the first and second aspects, process 1300 includes transmitting, to the receiver, signaling indicating multiple sets of candidate aggregation levels, the KDI indicates a set of candidate aggregation levels, of the multiple sets of candidate aggregation levels, associated with the next control information transmission.

In a fourth aspect, alone or in combination with one or more of the first through third aspects, process 1300 includes transmitting, to the receiver, signaling indicating a bitwidth of the KDI.

In a fifth aspect, alone or in combination with one or more of the first through fourth aspects, the KDI has a fixed bitwidth.

In a sixth aspect, alone or in combination with one or more of the first through fifth aspects, the KDI is carried in the control information transmission preceding the next control information transmission.

In a seventh aspect, alone or in combination with one or more of the first through sixth aspects, the KDI is multiplexed with a data transmission preceding the next control information transmission.

In an eighth aspect, alone or in combination with one or more of the first through seventh aspects, the KDI is carried on a last symbol in a slot in which the data transmission is transmitted.

In a ninth aspect, alone or in combination with one or more of the first through eighth aspects, the KDI is carried on an earliest symbol among a first symbol that is a configured number of symbols before a last symbol in a slot in which the data transmission is transmitted or a second symbol corresponding to a last symbol of the data transmission.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIG. 9-11. Additionally, or alternatively, the apparatus 1400 may be configured to perform one or more processes described herein, such as process 1200 of FIG. 12, process 1300 of FIG. 13, or a combination thereof. In some aspects, the apparatus 1400 and/or one or more components shown in FIG. 14 may include one or more components of the UE described in connection with FIG. 1 and FIG. 2. Additionally, or alternatively, one or more components shown in FIG. 14 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

In some aspects, the reception component 1402 may receive a KDI indicating whether a next control information transmission comprises one or more fields associated with values that are unchanged with respect to a preceding control information transmission. The reception component 1402 may receive the next control information transmission. The communication manager 1406 may decode the next control information transmission in accordance with the KDI.

In some aspects, the transmission component 1404 may transmit, to a receiver, a KDI indicating whether a next control information transmission comprises one or more fields associated with values that are unchanged with respect to a preceding control information transmission. The transmission component 1404 may transmit, to the receiver, the next control information transmission, wherein the receiver is configured to decode the next control information transmission in accordance with the KDI.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIG. 9-11. Additionally, or alternatively, the apparatus 1500 may be configured to perform one or more processes described herein, such as process 1200 of FIG. 12, process 1300 of FIG. 13, or a combination thereof. In some aspects, the apparatus 1500 and/or one or more components shown in FIG. 15 may include one or more components of the network node described in connection with FIG. 1 and FIG. 2. Additionally, or alternatively, one or more components shown in FIG. 15 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

In some aspects, the reception component 1502 may receive a KDI indicating whether a next control information transmission comprises one or more fields associated with values that are unchanged with respect to a preceding control information transmission. The reception component 1502 may receive the next control information transmission. The communication manager 1506 may decode the next control information transmission in accordance with the KDI.

In some aspects, the transmission component 1504 may transmit, to a receiver, a KDI indicating whether a next control information transmission comprises one or more fields associated with values that are unchanged with respect to a preceding control information transmission. The transmission component 1504 may transmit, to the receiver, the next control information transmission, wherein the receiver is configured to decode the next control information transmission in accordance with the KDI.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a receiver, comprising: receiving, by the receiver, a KDI indicating whether a next control information transmission comprises one or more fields associated with values that are unchanged with respect to a preceding control information transmission; receiving, by the receiver, the next control information transmission; and decoding, by the receiver, the next control information transmission in accordance with the KDI.
Aspect 2: The method of Aspect 1, wherein decoding the next control information transmission comprises: obtaining, from the preceding control information transmission, the unchanged values associated with the one or more fields in accordance with the KDI indicating that the next control information transmission comprises the one or more fields associated with the unchanged values.
Aspect 3: The method of any of Aspects 1-2, wherein decoding the next control information transmission comprises: determining multiple candidate aggregation levels for the next control information transmission in accordance with the KDI indicating that the next control information transmission comprises the one or more fields associated with the unchanged values; and performing blind decoding for the next control information transmission across the multiple candidate aggregation levels for the next control information transmission.
Aspect 4: The method of Aspect 3, further comprising: receiving, from a transmitter, signaling indicating the multiple candidate aggregation levels for the next control information transmission.
Aspect 5: The method of any of Aspects 1-4, further comprising: receiving, from a transmitter, signaling indicating multiple sets of candidate aggregation levels, wherein the KDI indicates a set of candidate aggregation levels, of the multiple sets of candidate aggregation levels, associated with the next control information transmission, and wherein decoding the next control information transmission comprises: performing blind decoding for the next control information transmission across one or more candidate aggregation levels associated with the set of candidate aggregation levels indicated in the KDI.
Aspect 6: The method of any of Aspects 1-5, further comprising: receiving, from a transmitter, signaling indicating a bitwidth of the KDI.
Aspect 7: The method of any of Aspects 1-6, wherein the KDI has a fixed bitwidth.
Aspect 8: The method of any of Aspects 1-7, wherein the KDI is carried in the control information transmission preceding the next control information transmission.
Aspect 9: The method of any of Aspects 1-8, wherein the KDI is multiplexed with a data transmission preceding the next control information transmission.
Aspect 10: The method of Aspect 9, wherein the KDI is carried on a last symbol in a slot in which the data transmission is received.
Aspect 11: The method of Aspect 9, wherein the KDI is carried on an earliest symbol among a first symbol that is a configured number of symbols before a last symbol in a slot in which the data transmission is received or a second symbol corresponding to a last symbol of the data transmission.
Aspect 12: A method of wireless communication performed by a transmitter, comprising: transmitting, by the transmitter to a receiver, a KDI indicating whether a next control information transmission comprises one or more fields associated with values that are unchanged with respect to a preceding control information transmission; and transmitting, to the receiver, the next control information transmission, wherein the receiver is configured to decode the next control information transmission in accordance with the KDI.
Aspect 13: The method of Aspect 12, further comprising: reducing an aggregation level for the next control information transmission, relative to the control information transmission preceding the next control information transmission, in accordance with the KDI indicating that the next control information transmission comprises the one or more fields associated with the unchanged values.
Aspect 14: The method of Aspect 13, further comprising: transmitting, to the receiver, signaling indicating the multiple candidate aggregation levels for the next control information transmission.
Aspect 15: The method of any of Aspects 12-14, further comprising: transmitting, to the receiver, signaling indicating multiple sets of candidate aggregation levels, wherein the KDI indicates a set of candidate aggregation levels, of the multiple sets of candidate aggregation levels, associated with the next control information transmission.
Aspect 16: The method of any of Aspects 12-15, further comprising: transmitting, to the receiver, signaling indicating a bitwidth of the KDI.
Aspect 17: The method of any of Aspects 12-16, wherein the KDI has a fixed bitwidth.
Aspect 18: The method of any of Aspects 12-17, wherein the KDI is carried in the control information transmission preceding the next control information transmission.
Aspect 19: The method of any of Aspects 12-18, wherein the KDI is multiplexed with a data transmission preceding the next control information transmission.
Aspect 20: The method of Aspect 19, wherein the KDI is carried on a last symbol in a slot in which the data transmission is transmitted.
Aspect 21: The method of Aspect 19, wherein the KDI is carried on an earliest symbol among a first symbol that is a configured number of symbols before a last symbol in a slot in which the data transmission is transmitted or a second symbol corresponding to a last symbol of the data transmission.
Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.
Aspect 23: An apparatus for wireless communication at a device, the apparatus comprising one or more memories and one or more processors coupled to the one or more memories, the one or more processors configured to cause the device to perform the method of one or more of Aspects 1-21.
Aspect 24: An apparatus for wireless communication, the apparatus comprising at least one means for performing the method of one or more of Aspects 1-21.
Aspect 25: A non-transitory computer-readable medium storing code for wireless communication, the code comprising instructions executable by one or more processors to perform the method of one or more of Aspects 1-21.
Aspect 26: A non-transitory computer-readable medium storing a set of instructions for wireless communication, the set of instructions comprising one or more instructions that, when executed by one or more processors of a device, cause the device to perform the method of one or more of Aspects 1-21.
Aspect 27: A device for wireless communication, the device comprising a processing system that includes one or more processors and one or more memories coupled with the one or more processors, the processing system configured to cause the device to perform the method of one or more of Aspects 1-21.
Aspect 28: An apparatus for wireless communication at a device, the apparatus comprising one or more memories and one or more processors coupled to the one or more memories, the one or more processors individually or collectively configured to cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a receiver, comprising:
one or more memories; and
one or more processors, the one or more processors, individually or collectively and based at least in part on information stored in the one or more memories, being configured to:
receive a known data indicator (KDI) indicating whether a next control information transmission comprises one or more fields associated with values that are unchanged with respect to a preceding control information transmission;
receive the next control information transmission; and
decode the next control information transmission in accordance with the KDI.

2. The apparatus of claim 1, wherein the one or more processors, to decode the next control information transmission, are configured to:
obtain, from the preceding control information transmission, the unchanged values associated with the one or more fields in accordance with the KDI indicating that the next control information transmission comprises the one or more fields associated with the unchanged values.

3. The apparatus of claim 1, wherein the one or more processors, to decode the next control information transmission, are configured to:
determine multiple candidate aggregation levels for the next control information transmission in accordance with the KDI indicating that the next control information transmission comprises the one or more fields associated with the unchanged values; and
perform blind decoding for the next control information transmission across the multiple candidate aggregation levels for the next control information transmission.

4. The apparatus of claim 3, wherein the one or more processors are further configured to:
receive, from a transmitter, signaling indicating the multiple candidate aggregation levels for the next control information transmission.

5. The apparatus of claim 1, wherein the one or more processors are further configured to:
receive, from a transmitter, signaling indicating multiple sets of candidate aggregation levels, wherein the KDI indicates a set of candidate aggregation levels, of the multiple sets of candidate aggregation levels, associated with the next control information transmission, and wherein the one or more processors, to decode the next control information transmission, are configured to:
perform blind decoding for the next control information transmission across one or more candidate aggregation levels associated with the set of candidate aggregation levels indicated in the KDI.

6. The apparatus of claim 1, wherein the one or more processors are further configured to:
receive, from a transmitter, signaling indicating a bitwidth of the KDI.

7. The apparatus of claim 1, wherein the KDI has a fixed bitwidth.

8. The apparatus of claim 1, wherein the KDI is carried in the control information transmission preceding the next control information transmission.

9. The apparatus of claim 1, wherein the KDI is multiplexed with a data transmission preceding the next control information transmission.

10. The apparatus of claim 9, wherein the KDI is carried on a last symbol in a slot in which the data transmission is received.

11. The apparatus of claim 9, wherein the KDI is carried on an earliest symbol among a first symbol that is a configured number of symbols before a last symbol in a slot in which the data transmission is received and a second symbol corresponding to a last symbol of the data transmission.

12. A method of wireless communication performed by a transmitter, comprising:
receiving, by the receiver, a known data indicator (KDI) indicating whether a next control information transmission comprises one or more fields associated with values that are unchanged with respect to a preceding control information transmission;
receiving, by the receiver, the next control information transmission; and
decoding, by the receiver, the next control information transmission in accordance with the KDI.

13. The method of claim 12, wherein decoding the next control information transmission comprises:
obtaining, from the preceding control information transmission, the unchanged values associated with the one or more fields in accordance with the KDI indicating that the next control information transmission comprises the one or more fields associated with the unchanged values.

14. The method of claim 12, wherein decoding the next control information transmission comprises:
determining multiple candidate aggregation levels for the next control information transmission in accordance with the KDI indicating that the next control information transmission comprises the one or more fields associated with the unchanged values; and
performing blind decoding for the next control information transmission across the multiple candidate aggregation levels for the next control information transmission.

15. The method of claim 14, further comprising:
receiving, from a transmitter, signaling indicating the multiple candidate aggregation levels for the next control information transmission.

16. The method of claim 12, further comprising:
receiving, from a transmitter, signaling indicating multiple sets of candidate aggregation levels, wherein the KDI indicates a set of candidate aggregation levels, of the multiple sets of candidate aggregation levels, associated with the next control information transmission, and wherein decoding the next control information transmission comprises:
performing blind decoding for the next control information transmission across one or more candidate aggregation levels associated with the set of candidate aggregation levels indicated in the KDI.

17. The method of claim 12, wherein the KDI is carried in the control information transmission preceding the next control information transmission.

18. The method of claim 12, wherein the KDI is multiplexed with a data transmission preceding the next control information transmission.

19. The method of claim 18, wherein the KDI is carried on:
a last symbol in a slot in which the data transmission is received, or
an earliest symbol among a first symbol that is a configured number of symbols before a last symbol in a slot in which the data transmission is received and a second symbol corresponding to a last symbol of the data transmission.

20. An apparatus for wireless communication at a transmitter, comprising:
one or more memories; and
one or more processors, the one or more processors, individually or collectively and based at least in part on information stored in the one or more memories, being configured to:
transmit, to a receiver, a known data indicator (KDI) indicating whether a next control information transmission comprises one or more fields associated with values that are unchanged with respect to a preceding control information transmission; and
transmit, to the receiver, the next control information transmission, wherein the receiver is configured to decode the next control information transmission in accordance with the KDI.
